(19) United States
(12) Patent Application Publication
(10) Pub. No.: US 2009/0228352 A1
(43) Pub. Date: Sep. 10, 2009

(54) TRANSACTIONS, PAYMENT AND EMERGENCY MEDICAL SYSTEM

(75) Inventors: DAVID WAXMAN, Philadelphia, PA (US); Jason Brown, Philadelphia, PA (US)

Correspondence Address: COZEN O'CONNOR, P.C., 1900 MARKET STREET, PHILADELPHIA, PA, 19103-3508, US

(73) Assignee: JBDW HOLDINGS, LLC, Philadelphia, PA (US)

(21) Appl. No.: 12/042,176

(22) Filed: Mar. 4, 2008

(51) Int. Cl. G06Q 30/00

(52) U.S. Cl. 705/14; 705/35

(57) ABSTRACT

A system comprising a device adapted to be worn by an individual, which provides personal identification of the owner in case of incapacity and also be used as an e-wallet that integrates contactless payment technology to substitute the petty cash that people carry along when exercising. Additional functionalities that can be integrated onto the card include store loyalty cards, membership cards, keys and public transportation cards. The device has an interchangeable form that holds a card. The card can also be used as a debit card to draw funds and purchase items at point of sale terminals with compatible technology while providing medical and personal information to emergency medical responders.

### BACKGROUND OF THE INVENTION

The present invention relates to identification systems in general and in particular to medical information system, which integrates contactless payment and targeted advertising.

While participating in exercise programs at a gym, playing golf, running, biking, or any of a wide variety of activities, individuals often do not carry their wallets or pocketbooks and therefore, do not carry money or identification. In many cases, such individuals would like to purchase something during a break in their physical activity, but are unable to because they did not bring their wallet or pocketbook. Furthermore, due to the lack of carried identification in such situations, a very serious problem can occur if the individual has a medical emergency, which renders them unconscious. The emergency personnel may not be aware of a person's medical conditions such as allergy, cardiac status and the like.

While this problem has been recognized and others have suggested solutions such as “Medic-Alert” bracelets, such bracelets suffer from certain disadvantages, for example, it is difficult to update the medical information inscribed on such bracelets. Further, such bracelets do not allow a user to purchase goods or services.

Therefore, what is needed is a secure and convenient way for emergency medical personnel to retrieve a party's up to date medical identification while providing the active adult with a contactless facility to store cash used for everyday purchases while participating in a wide range of outdoor sports and activities.

### SUMMARY OF THE INVENTION

Therefore, the present invention provides a solution to the above problems, and it is an object of the present invention to provide a system for communicating medical and personal information to emergency medical responders in a device, which can be worn by an individual while exercising, the same device providing stored cash value which can be used to purchase items.

It is another object of the present invention to provide for an initial registration of user account information.

It is a further object of the present invention to provide a transaction processing system for receiving user account information from said terminal, authorizing payment, displaying medical and transactional information based on said user account information. Optionally, a user may choose to receive targeted advertising and other promotional messages.

According to one aspect of the present invention, there is provided a system for payment for goods or services and access to medical information comprising: a single device adapted to be worn by an individual, the device comprising (a) means to store data therein; and (b) means to read data stored on the device wherein the data enables financial payment to a vendor and access to medical information. Optionally, the device further comprises a magnetic strip so that a payment can be authorized by swiping through a credit card reader if the point of sale terminal doesn't offer contactless functionality.

In some embodiments, the system further comprises a terminal for initial registration of user account information; a transaction processing system for receiving user account information from said terminal, authorizing payment, displaying medical information based on said user account information.

In some embodiments, the medical information can be updated by the individual or a medical provider. The system further comprises in certain embodiments a Radio Frequency ID (RFID) compatible circuitry enabling wireless transactions. In some embodiments, the system includes a band adapted to receive and hold the device to be worn by an individual.

According to another aspect of the present invention, there is provided a method for payment for goods or services and access to medical information comprising: (a) registering a user's medical information over the Internet; (b) storing cash value in the account associated with the device; (c) using the device to pay for goods or services; and (d) using the device by an emergency responder to access the user's medical information. The medical information can be stored, for example, on one of a remote server or locally on the device and can be retrieved by emergency responders using one of a reader connected to the Internet, by dialing a telephone number and entering a unique identification information printed on the device, by accessing a web site and entering the identification information. Further, the medical information can be updated by the individual or a medical provider in some embodiments. The method can include the steps of registering an initial user account information at a terminal; performing a transaction for receiving user account information from said terminal, authorizing payment, displaying medical information based on said user account information. Lastly, the method can comprise adapting a band to receive and hold the device to be worn by an individual.

The method can include checking balance; reviewing recent transaction history, adding funds via PayPal, credit card, bank account, all associated with the user's account which is associated with the device. These features are optional.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an embodiment of a system of the invention;

FIG. 2 illustrates a user wearing the device of the invention in a band;

FIG. 3 is a front elevational view of a band holding a stored value and medical information card according to the invention;

FIG. 4 is a flow chart of a method according to the invention.

### DETAILED DESCRIPTION OF PREFERRED EMBODIMENTS

Preferred embodiments of the present invention will be described in detail herein below with reference to the accompanying drawings.

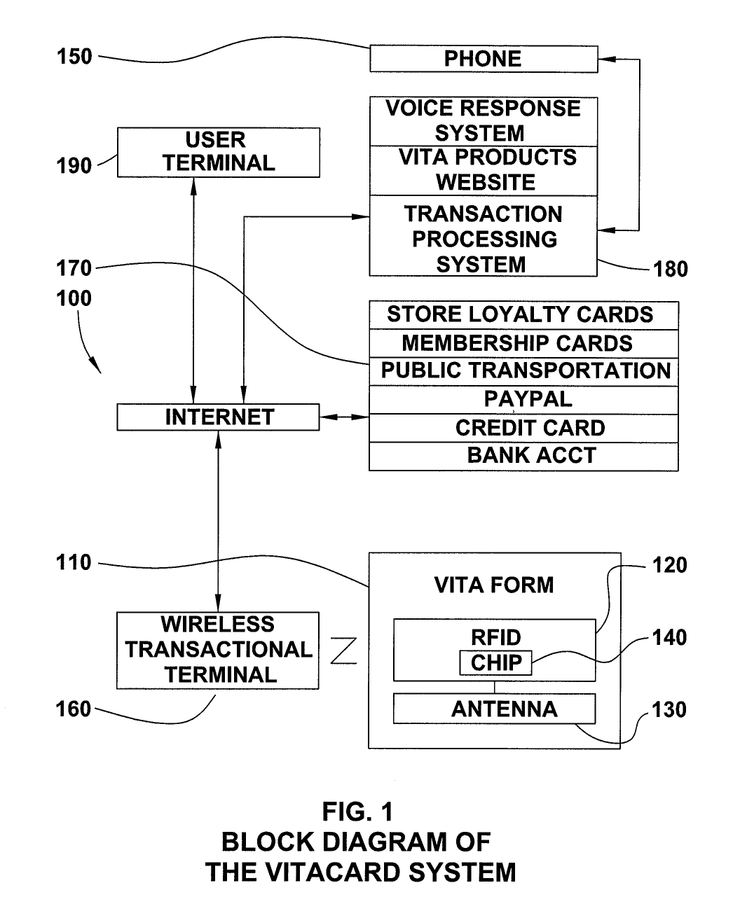

FIG. 1 is a block diagram illustrating a preferred contactless facility 100. According to this illustrative example, the contactless bracelet 110 is equipped with an integral contactless card 120 and radio frequency antenna 130. The chip 140 includes the Emergency Response Profile (ERP) or medical information that can be used by system 100 to enable contactless transactions. User terminal 190 is used to initiate the registration process and integrate functionalities such as store loyalty cards, public transportation passes 170. User terminal 190 is any internet capable device. Phone 150 is used to dial toll free Automated Voice Response System 180.

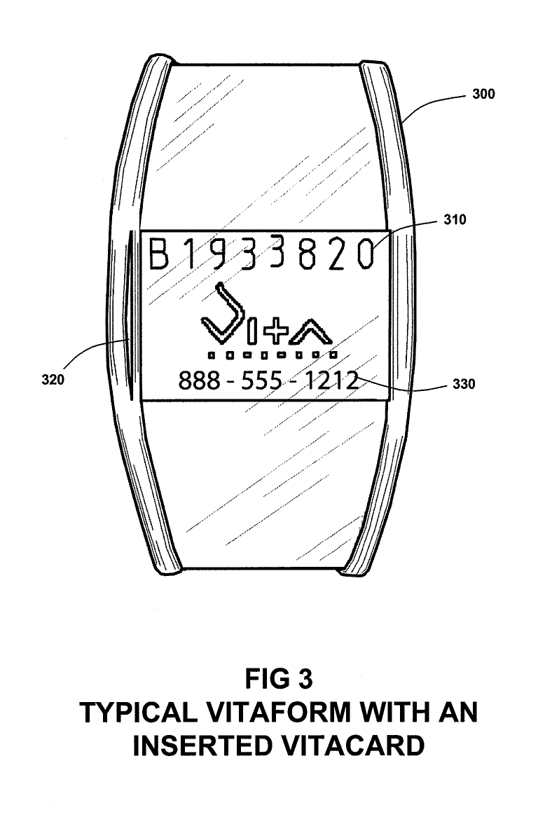

According to one embodiment, the contactless payment system chip is embedded in the card. FIG. 3 shows the bracelet 300 and the card 320. The card is inserted via a sleeve as shown. Particularly, the card is removable and can fit into a wide variety of forms including but not limited to bracelets, anklets, watch bands, and key chains. A unique number 310 as well as a toll free telephone number 330 are prominently printed on the bracelet. The card has the ability to enable/disable the use of the payment functionality of the contactless payment system chip. This is done via the website provided to the consumer upon sign-up. Just like a credit card, the card is assumed to be valid if it has not been reported lost or stolen. The card can be reported lost or stolen either by phone or by logging into the web site at www.vitaband.net.

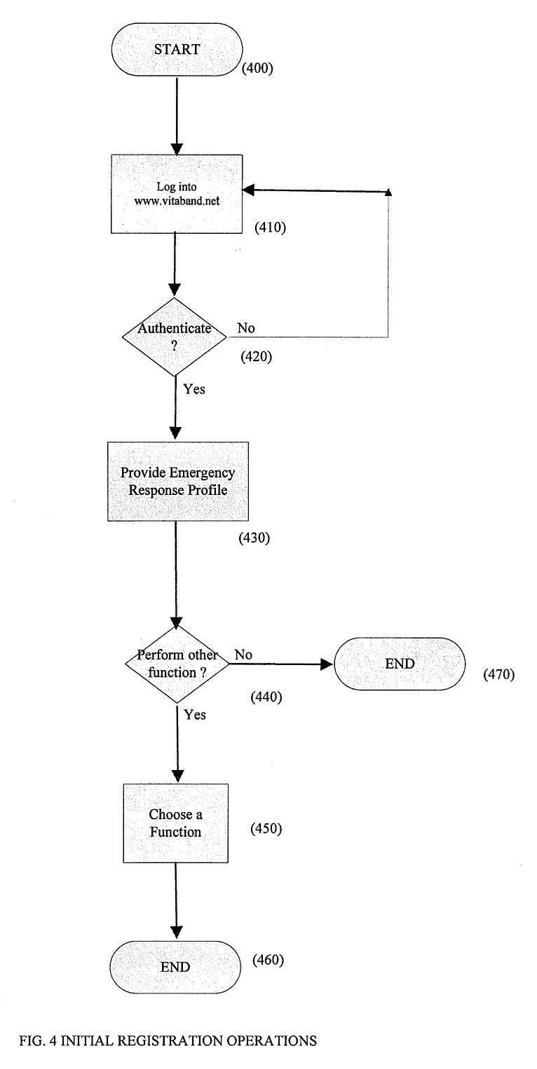

FIG. 4 is a flow chart illustrating a method of initial registration of the device. In steps 400 and 410, after purchasing a bracelet, the consumer will log into the web site to create their secure, online Emergency Response Profile (ERP) or medical information. In step 420, the user is authenticated by providing a username and password where the username is the unique numerical identifier printed on each Card and assigned to each customer. For an added layer of security, a separate username may be used as the unique number is available for all to see. Upon successful completion of the authentication process, in step 430 the user is allowed to complete the Emergency Response Profile (ERP) form. The ERP consists of the following eight (8) categories of information with the consumer having complete control of their ERP with unlimited access to update and supply as much or as little of this information as they deem appropriate. The information enterered into the Vita data base (VitaDB) includes name and vital statistics, addresses (up to 3), emergency contacts (up to 3), physician contacts (up to 5), medical profile, health insurance, government ID (i.e., SSN, SIN, etc. . . . ), a picture and any other additional information to further personalize the card. The database is designed to integrate with other online health record systems for sharing of information, at the customer's election. The card contains the contactless payment chip and the Unique identification number is printed on the card for each customer. The Unique identification number is the link that connects the ERP to the user. After the required registration or activation procedures have been completed, the card now holds relevant data and is able to send and receive communication signals. In step 440, the user is given the option to perform another function or to end 470 the initial registration step.

The Website is also the conduit for a user to link their card with their bank account, credit card or alternative funding sources (such as PayPal). The card is the equivalent of a debit card, drawing funds from the user's designated funding sources to purchase items at point of sale terminals with compatible technology. In step 450, the user is given the option to check balance; review recent transaction history; add funds via PayPal, credit card, bank account; limit the use of funds and/or create rules for use of funds; or freeze the account in the event the card is lost or stolen. If no function is chosen, the process ends 460.

In another embodiment, when a user desires to initiate a contactless transaction, for example, payment for a purchased item, the user brings Bracelet 110 into close proximity (less than 2-4 inches) to a wireless transactional terminal or reader 160 as shown in FIG. 1. contactless payments are simply payment transactions that require no physical contact between the consumer payment device and the physical point-of-sale (POS) terminal. The wireless transactional terminal or reader emits a signal that couples to the antenna of the bracelet. The signal is then propagated to the chip on the card. Every card contains a contactless payment chip based on the industry accepted ISO/IEC 14443 Type B Proximity contactless ID card standard. The card is linked to a user's designated bank account, credit card or other payment account, allowing the user to carry the equivalent of a debit card without the bulkiness of a wallet. Upon activation, the chip through the antenna transmits the relevant information to the wireless transactionalterminal or reader. Transaction processing system 180 verifies the information received from the wireless transactional terminal or reader. The transaction processing system then provides an indication to the wireless transactional terminal or reader via the Internet whether the transsaction is approved or declined. Alternatively, card 120 is equipped with a magnetic strip so it can be used the conventional way by swiping the card.

Additional functionalities that can be integrated on to the card include store loyalty cards (i.e. supermarket, drugstores, videostores, etc.), membership cards (gyms, clubs, etc.), keys (cars, house equiped with RFID), public transportation cards (i.e. bus pass, metrocard pass, etc.) or any wireless enabled apparatus. The card would perform the exact same function as anyone of these cards listed above following the same principle as when a user desires to initiate a contactless transaction articulated above.

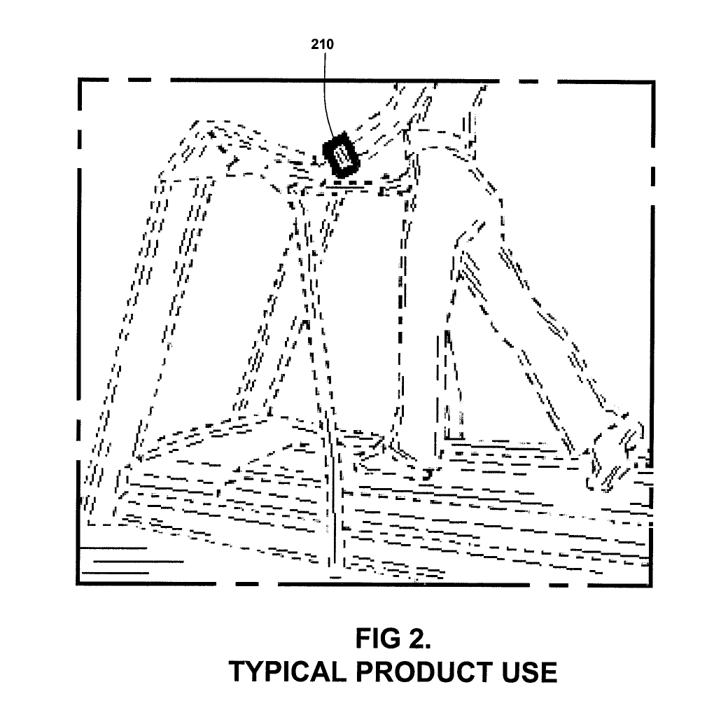

FIG. 2 shows an individual wearing the card. In operation, the Bracelet is used in the same manner in which a conventional RFID bracelets are used. The bracelet is attached to the wrist or other body part of a user when exercising. In the event of an accident and if the individual is unconscious, incapacitated or unable to provide vital information to medical personnel, first responders will find the VitaBand or Bracelet and see the Unique identification number as well as instructions on how to access that person's Emergency Response Profile (ERP) prominently printed on the bracelet and the card. At this point, the medical personnel has the option of using the Voice Response System (VRS), the Website or use a reader. The Emergency Medical Personnel can dial Vita products' toll free Automated Voice Response System (printed on the bracelet and card) and enter the individual's Unique identification number. Once verified, the sophisticated text to voice engine will provide all the information in the individual's ERP to ensure medical personnel are provided with the health history, emergency contact information, insurance information and other pertinent data that will enable medical personnel to make timely decisions when administering treatment.

Medical personnel can also go the secure website at www.vitaband.net and input the individual's Unique identification number to gain access to the ERP.

If the medical personnel or first responders is equiped with a reader, it must be brought within a certain distance of the armband, which transmits a wireless signal representative of the unique information of the individual with all the vital statistics including the individual's photo for positive identification.

In another embodiment, when a user opts to integrate any of the membership or store loyalty cards onto the card, the user will be prompted to choose whether to accept advertising or not. If the answer is affirmative, the RFID would interact with terminals in stores, malls identifying the presence of the user. The store would then via the web site (vitaband.net) send targeted messages to the wearer. Those messages could include targeted advertising, coupons and other promotional messages.

Although the preferred embodiments of the present invention have been disclosed for illustrative purposes, an artisan of ordinary skill in the art will readily understand that various modifications, additions and substitutions are possible, without departing from the scope and spirit of the invention as further defiened by the accompanying claims.

We claim:

1. A system for payment for goods or services and access to medical information comprising:
a single device adapted to be worn by an individual, the device comprising:
(a) means to store data therein; and
(b) means to read data stored on the device wherein the data enables financial payment to a vendor and access to medical and transactional information.

2. The system of claim 1, further comprising a terminal for initial registration of user account information, integration of store loyalty cards, keys, membership cards, public transportation passes and wireless enabled devices.

3. The system of claim 1, further comprising a transaction processing system for receiving user account information from said terminal, authorizing payment, displaying medical and transactional information based on said user account information.

4. The system of claim 3 wherein transactional information further comprises targeted advertising, coupons, promotional messages.

5. The system of claim 1, wherein the medical information is stored on one of a remote server or locally on the device and can be retrieved by emergency responders either using a reader connected to the Internet, by dialing a telephone number and entering an identification information printed on the device, or by accessing a web site and entering the identification information.

6. The system of claim 1, wherein the medical information can be updated by the individual or a medical provider.

7. The system of claim 1, wherein the device comprises a Radio Frequency ID (RFID) compatible circuitry enabling wireless transactions.

8. The system of claim 1, wherein the device further comprising a magnetic strip so that a payment can be authorized by swiping through a credit card reader.

9. The system of claim 1, wherein the device further comprises a removable card that can fit into a variety of forms while maintaining the same functionalities.

10. The system of claim 8, wherein the forms comprise various styles of bracelets, key chains, anklets, sleeves and necklaces.

11. A method for payment for goods or services and access to medical information comprising:
(a) registering a user's medical information over the Internet;
(b) storing cash value in the account associated with the device;
(c) using the device to pay for goods or services; and
(d) using the device by an emergency responder to access the user's medical information.

12. The method of claim 11, further comprising storing the medical information on a remote server or locally on the device so that the medical information can be retrieved by emergency responders using a reader connected to the Internet, by dialing a telephone number and entering an identification information printed on the device, by accessing a web site and entering the identification information.

13. The method of claim 11, wherein the medical information can be updated by the individual or a medical provider.

14. The method of claim 11, further comprising registering an initial user account information at a terminal, integrating store loyalty cards, keys, membership cards and public transportation passes.

15. The method of claim 11, further comprising performing a transaction for receiving user account information from said terminal, authorizing payment, displaying medical and transactional information based on said user account information.

16. The method of claim 15 wherein transactional information further comprises targeted advertising, coupons, promotional messages.

17. The method of claim 11, further comprising providing a band to receive and hold the device and to be worn by an individual.

18. The method of claim 11, further comprising providing means to determine an individual's cash account balance associated with the device; review recent transaction history associated with the device, add funds to the user's account associated with the device, or freeze the account associated with the device.

19. The method of claim 11, further comprising establishing a line of credit for use when the account balance associated with the device is zero.
